(19) United States
(12) Patent Application Publication
(10) Pub. No.: US 2002/0083151 A1
(43) Pub. Date: Jun. 27, 2002

(54) System and method for database access and management

(76) Inventors: Robert Adams, Lake Oswego, OR (US); Jose P. Puthenkulam, Beaverton, OR (US)

Correspondence Address: SCOTT C. HARRIS, Fish & Richardson P.C., Suite 500, 4350 La Jolla Village Drive, San Diego, CA, 92122, US

(21) Appl. No.: 09/745,594

(22) Filed: Dec. 22, 2000

(51) Int. Cl. G06F 15/16

(52) U.S. Cl. 709/217; 709/215

(57) ABSTRACT

A portable appliance has access to database information even when a remote device is turned off. A cache device is designed to be always on. The cache device stores communications from the portable wireless communication device and forwards them to a remote device when it is available. The cache device may also store a copy of a portion of the database. Thus this portion of the database is always available to the portable communication device even when the remote device is unavailable

### BACKGROUND

1. Field

The subject matter described herein relates generally to the field of database access and management.

2. Background

Portable computing and communicating appliances are becoming increasingly popular. Examples of such appliances include personal digital assistants, radiotelephones, and laptop computers, and other devices equipped with computing and wireless communication features. These appliances may communicate with a remote device having access to databases for a variety of reasons, for example, to send data to the databases or to obtain data from the databases. Often the remote device is a more capable computing device, for example, a personal computer or a desktop computer with a synchronization cradle for communicating with the appliance. These remote devices and the databases in turn, however, may not be accessible when the remote device is turned off.

### DESCRIPTION OF DRAWINGS

FIG. 1 is an electrical schematic of a communication system.

FIG. 2 is a flow chart of a method of accessing and managing databases.

### DETAILED DESCRIPTION

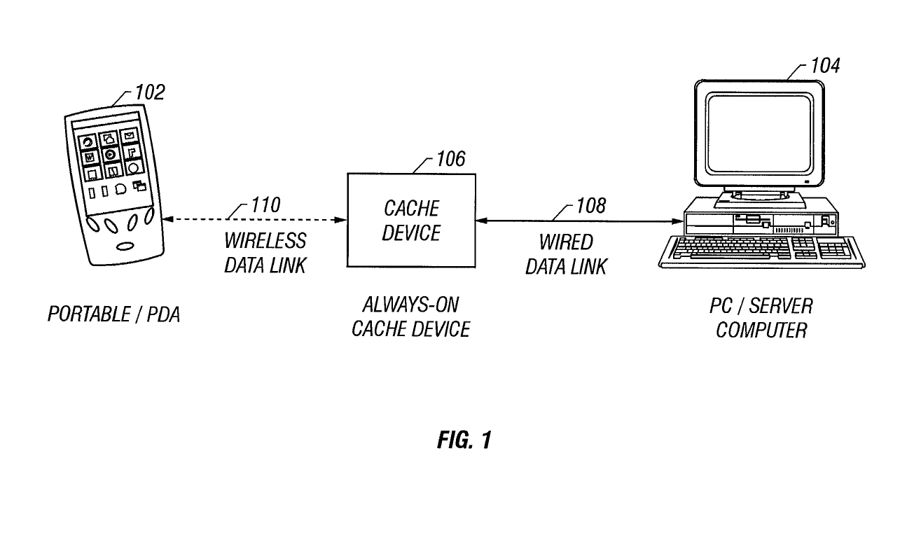

FIG. 1 is an electrical schematic of a particular communication system. The communication system comprises a portable wireless communication appliance 102, a remote device 104 with access to a database, and a cache device 106 configured to communicate wirelessly with the portable wireless communication appliance and to communicate with the remote device. The cache device may store a copy of a predetermined portion of the database.

The portable wireless communication appliance may comprise, for example, a radiotelephone, a personal digital assistant, a portable computer, or the like equipped with computing and wireless communication features.

The remote device may comprise, for example, a personal computer, a desktop computer, or a server device connected to a network. The database, which is stored on a device other than the portable wireless communication appliance, may be stored locally, for example, on the hard disk of the computer, or remotely, for example, on a server on the network.

The communication link 108 between the cache device and the remote device may comprise a bi-directional wired or wireless data link, for example, Universal Serial Bus or serial bus.

The cache device may comprise a storage device, a data processor for executing preprogrammed instructions and managing the copy of the portion of the database in the storage device, and a wireless communication device for communicating with the portable wireless communication device.

The data processor may be conventional processors, for example, Celeron™ or STRONGArm™ processors.

The storage device can comprise, for example, flash memory, dynamic random access memory, or magnetic storage medium.

The communication link 110 between the cache device and the portable wireless communication device may comprise a bi-directional wireless data link, for example, Bluetooth™ link or IEEE Standard for Information Technology 802.11 A or B.

The portable wireless communication device typically has limited memory and hence interaction with a larger database usually requires a powerful server computer or personal computer. As these computers may not always be available, an always-on device that can cache the data for the portable wireless communication device may allow more data intensive tasks to be carried out by the portable devices.

The cache device can cache, for example, ten to fifteen times the storage capacity of the portable communication device, and typically significantly less than the remote device.

The cache device may be designed to be always on. The cache device stores communications from the portable wireless communication device and forwards those communications to the remote device when it is available. The cache device may also store a copy of a portion of the database. Thus, this portion of the database is always available to the portable communication device even when the remote device is unavailable.

The cache device may cache data based upon user's preferences and configuration settings. Data on the remote device, for example, telephone numbers, address books, emails, documents, notes, and other information can be chosen to be cached and available all the time.

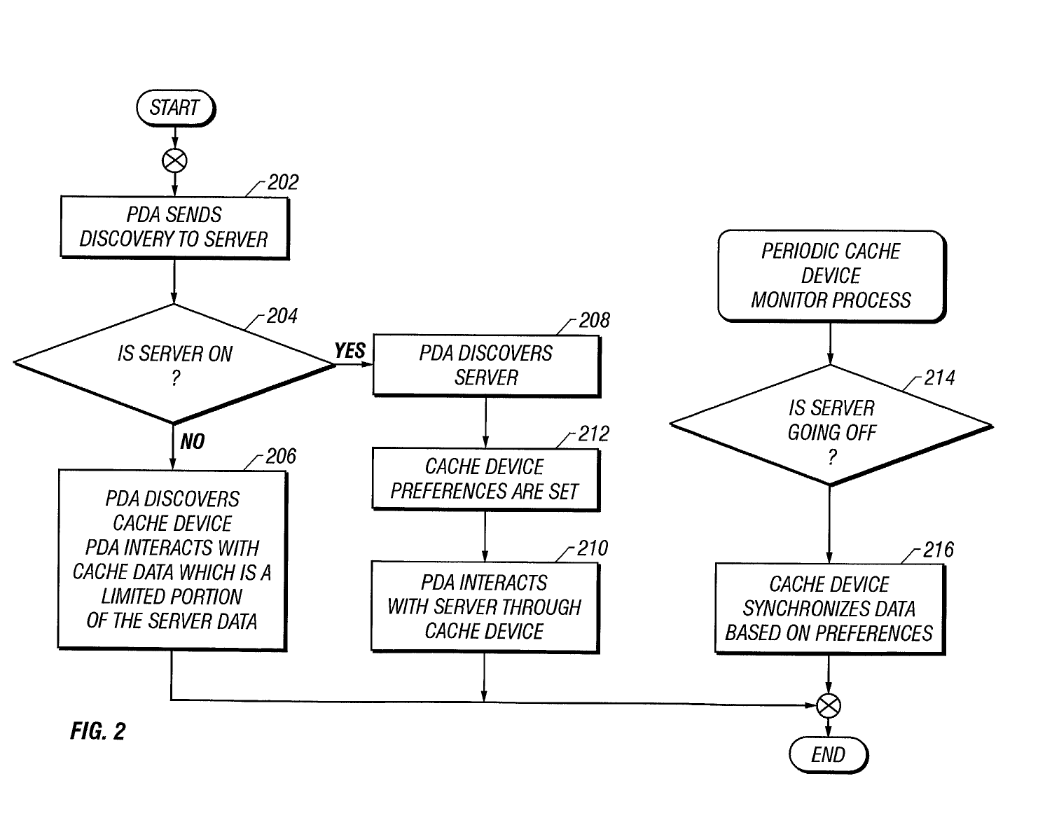

FIG. 2 is a flow chart of a method of accessing and managing databases. A wireless communication link is established between the portable wireless communication appliance and the cache device. The portable wireless communication appliance sends a remote-device discovery inquiry by way of the wireless communication link at 202. The cache device determines if the remote device is available, or turned on, for communication with the cache device at 204. The portable wireless communication appliance accesses the copy of the portion of the database stored in the cache device when the remote device is not available at 206. Otherwise, when the remote device is discovered at 208, the portable wireless communication appliance accesses the database when the remote device is available at 210.

Also, when the remote device is available, the portable wireless communication appliance may set the cache-device preferences at 212.

The cache device can monitor the availability of the remote device at 214. Prior to the unavailability of the remote device, the copy of the portion of the database can be synchronized with the database according to the cache-device preferences at 216. Thus, the portable wireless communication appliance will have access to the stored data even though the remote device is turned off.

The cache device may consume less power than the remote device. Thus, there may be an overall power savings even though the cache device is always on.

In conclusion, the communication system and methods described herein provide a portable appliance access to database information when the remote device is turned off.

A number of embodiments of the invention have been described. Nevertheless, it may be understood that various modifications may be made without departing from the spirit and scope of the invention. Accordingly, other embodiments are within the scope of the following claims.

What is claimed is:

1. A communication system for accessing and managing a database, comprising:
a portable wireless communication appliance;
a remote device with access to the database; and
a cache device configured to communicate wirelessly with the portable wireless communication appliance and to communicate with the remote device, the cache device storing a copy of a predetermined portion of the database.

2. The communication system of claim 1 wherein the portable wireless communication appliance comprises one of a radiotelephone, a personal digital assistant, or a portable computer.

3. The communication system of claim 1 wherein the remote device comprises a personal computer, a desktop computer, or a server device connected to a network.

4. The communication system of claim 1 wherein the cache device comprises:
a storage device for storing the copy of the portion of the database;
a data processor operative to execute preprogrammed instructions and managing the copy of the portion of the database in the storage device; and
a wireless communication device operative to communicate with the portable wireless communication device.

5. A method of accessing and managing a database accessible by a remote device, the method comprising:
establishing a wireless communication link between a portable wireless communication appliance and a cache device storing a portion of the database;
sending a remote-device discovery inquiry by way of the wireless communication link;
determining if the remote device is available for communication with the cache device; and
accessing the copy of the portion of the database stored in the cache device when the remote device is not available.

6. The method of claim 5 further comprising accessing the database when the remote device is available.

7. The method of claim 5 further comprising setting cache-device preferences when the remote device is available.

8. The method of claim 5 further comprising monitoring the availability of the remote device.

9. The further comprising of claim 8 further comprising synchronizing the copy of the portion of the database with the database according to the cache-device preferences prior to the unavailability of the remote device.

10. A computer program product embodied on a tangible storage medium, the program comprising executable instructions that enable a system to:
establish a wireless communication link between a portable wireless communication appliance and a cache device storing a portion of a database;
send a remote-device discovery inquiry by way of the wireless communication link;
determine if a remote device having access to the database is available for communication with the cache device; and
access the copy of the portion of the database stored in the cache device when the remote device is not available.

11. The computer program product of claim 10 further comprising executable instructions to access the database when the remote device is available.

12. The computer program product of claim 10 further comprising executable instructions to set cache-device preferences when the remote device is available.

13. The computer program product of claim 12 further comprising executable instructions to monitor the availability of the remote device.

14. The computer program product of claim 13 further comprising executable instructions to synchronize the copy of the portion of the database with the database according to the cache-device preferences prior to the unavailability of the remote device.

15. A method comprising:
establishing a wireless communication link between a portable wireless communication appliance and a cache device;
sending a remote-device discovery inquiry by way of the wireless communication link;
determining if a remote device is available for communication with the cache device;
setting cache-device preferences when the remote device is available;
monitoring the availability of the remote device; and
synchronizing a copy of a portion of a database stored in the cache device with the database stored in the remote device according to the cache-device preferences prior to the unavailability of the remote device.

16. The method of claim 15 further comprising accessing the copy of the portion of the database stored in the cache device when the remote device is not available.
